(19) United States
(12) Patent Application Publication
(10) Pub. No.: US 2016/0125825 A1
(43) Pub. Date: May 5, 2016

(54) DISPLAY PANEL, AND PIXEL STRUCTURE AND DRIVING METHOD THEREOF

(71) Applicant: SHENZHEN CHINA STAR OPTOELECTRONICS TECHNOLOGY CO. LTD., Shenzhen (CN)

(72) Inventor: Xiaohui YAO, Shenzhen (CN)

(21) Appl. No.: 14/416,878

(22) PCT Filed: Oct. 17, 2014
(86) PCT No.: PCT/CN2014/088851

§ 371 Date: Jan. 23, 2015

(30) Foreign Application Priority Data
Sep. 18, 2014 (CN) 201410478330.1

(51) Int. Cl. G09G 3/36

(52) U.S. Cl. CPC G09G 3/3648; G09G 3/3688; G09G 2300/0426; G09G 2300/0452; G09G 2310/0251

(57) ABSTRACT

The present disclosure relates to a display panel, and a pixel structure and a driving method thereof. The pixel structure comprises a plurality of sub-pixels, each of which comprises: a main portion configured to receive a scan signal on a first scan line, so as to receive a data signal on a data line and then have a main-portion voltage; a first portion electrically connected to the main portion and configured to receive the scan signal on the first scan line, so as to receive the main-portion voltage and then have a first-portion voltage; and a second portion configured to receive a scan signal on a second scan line, so as to receive the data signal on the data line and then have a second-portion voltage, wherein the main-portion voltage, the first-portion voltage, and the second-portion voltage are different from one another. The display panel not only achieves low color shift for 2D display, but also enables low color shift for 3D display by using a voltage difference between the main portion and the first portion after forming the second portion into a light shading area.

### CROSS-REFERENCE TO RELATED APPLICATIONS

The present disclosure claims benefit of Chinese patent application CN 201410478330.1, entitled “DISPAY PANEL, AND PIXEL STRUCTURE AND DRIVING METHOD THEREOF” and filed on Sep. 18, 2014, the disclosure of which is incorporated by reference herein in its entirety.

### TECHNICAL FIELD

The present disclosure relates to the image displaying technology, in particular, to a display panel having both two-dimension and three-dimension display capabilities, and a pixel structure and a driving method thereof.

### TECHNICAL BACKGROUND

With development of the display technology, three-dimensional display technology has become one of the most compelling technical trends so far. Film patterned retarder (FPR for short) is one of the mainstream technologies of three-dimensional display. In this technology, polarizing film is attached to a liquid crystal display panel, so that a three-dimensional image is split into a left-eye image and a right-eye image by means of cooperation of the polarizing film with polarizing glasses, and the resulting images are then transmitted separately to the left eye and the right eye of the viewer so as to enable the three-dimensional display. However, there is specific drawback in this technique. That is, crosstalk between the left and right eye images occurs when the image is viewed from a large viewing angle. This crosstalk causes an image that the viewer is watching to be blurred.

In addition, a large size liquid crystal display panel using a vertical alignment display mode (VA mode for short) presents a technical problem of color shift due to a large viewing angle. In this regard, the current manufacturers of liquid crystal display panels generally apply a charge-shared technology, in which a pixel electrode of each sub-pixel in a pixel structure is divided into two portions, i.e., a main zone and a sub zone. Driven by a same grayscale voltage, the main and sub zones are further exerted with different voltages, by means of which the liquid crystal molecules corresponding to the main and sub zones deflect over different deflection angles under control, thus enabling an effect of low color shift.

To avoid the phenomenon of crosstalk occurring in the three-dimensional display, during a design of a three-dimensional FPR pixel structure, the manufacturers of liquid crystal display panels may appropriately enlarge a shading distance between pixels located in adjacent upper and lower lines, but it would deteriorate the penetrability under the two-dimensional display. Meanwhile, the liquid crystal display panel is incapable of low color shift under a condition of the three-dimensional display. Therefore, how to further enable the LCD panels with an effect of low color shift as still taking account of both two-dimensional and three-dimensional display functions becomes a technical issue to be solve in the related industry.

### SUMMARY OF THE INVENTION

In order to solve the above problem, the present disclosure provides a display panel having both two-dimension and three-dimension display capabilities and further capable of a display effect of low color shift, and a pixel structure and a driving method thereof.

Provided in the present disclosure is a pixel structure comprising a plurality of sub-pixels, a pixel electrode of each sub-pixel comprising:

a main portion, configured to receive a scan signal of a first scan line, so as to receive a data signal of a data line and then have a main-portion voltage;

a first portion, electrically connected to the main portion and configured to receive the scan signal of the first scan line, so as to receive the main-portion voltage and then have a first-portion voltage; and

a second portion, configured to receive a scan signal of a second scan line, so as to receive the data signal of the data line and then have a second-portion voltage,

wherein the main-portion voltage, the first-portion voltage, and the second-portion voltage are different from one another.

According to an embodiment of the present disclosure, the main portion is electrically connected to the data line through a first electrode and a second electrode of a main-portion charging switch, and a control terminal of the main-portion charging switch is electrically connected to the first scan line. Meanwhile, the main portion is further electrically connected with a main-portion liquid crystal capacitor and a main-portion storage capacitor.

According to an embodiment of the present disclosure, the first portion is electrically connected to the main portion through a first electrode and a second electrode of a first-portion charging switch, and a control terminal of the first-portion charging switch is electrically connected to the first scan line. Meanwhile, the first portion is further electrically connected with a first-portion liquid crystal capacitor and a first-portion storage capacitor, wherein two ends of either the first-portion liquid crystal capacitor or the first-portion storage capacitor are electrically connected to a first electrode and a second electrode of a first-portion discharge switch, a control terminal of which discharge switch is electrically connected to the first scan line.

According to an embodiment of the present disclosure, the second portion is electrically connected to the data line through a first electrode and a second electrode of a second-portion charging switch, a control terminal of which charging switch is electrically connected to the second scan line. The second portion is further electrically connected with a second-portion liquid crystal capacitor and a second-portion storage capacitor, wherein two ends of either the second-portion liquid crystal capacitor or the second-portion storage capacitor are electrically connected to a first electrode and a second electrode of a second-portion discharge switch, a control terminal of which discharge switch is electrically connected to the second scan line.

According to an embodiment of the present disclosure, the main-portion liquid crystal capacitor, the first-portion liquid crystal capacitor, and the second-portion liquid crystal capacitor are constituted respectively by the main portion, the first portion, and the second portion with a common electrode of a color filter substrate, and the main-portion storage capacitor, the first-portion storage capacitor, and the second-portion storage capacitor are constituted respectively by the main portion, the first portion, and the second portion with an array substrate where the main portion, the first portion, and the second portion are located.

In addition, the present disclosure further provides a display panel comprising:

a plurality of data lines;

a plurality of scan lines forming a plurality of sub-pixel regions by means of a staggered arrangement with the data lines; and

a plurality of sub-pixels arranged inside the sub-pixel regions, a pixel electrode of each of the sub-pixel comprising:
a main portion, configured to receive a scan signal of a first scan line, so as to receive a data signal of a data line and then have a main-portion voltage;
a first portion, electrically connected to the main portion and configured to receive the scan signal of the first scan line, so as to receive the main-portion voltage and then have a first-portion voltage; and
a second portion, configured to receive a scan signal of a second scan line, so as to receive the data signal of the data line and then have a second-portion voltage,
wherein the main-portion voltage, the first-portion voltage, and the second-portion voltage are different from one another.

According to an embodiment of the present disclosure, the main portion is electrically connected to the data line through a first electrode and a second electrode of a main-portion charging switch, and a control terminal of the main-portion charging switch is electrically connected to the first scan line, and the main portion is further electrically connected with a main-portion liquid crystal capacitor and a main-portion storage capacitor.

The above-mentioned first portion is electrically connected to the main portion through a first electrode and a second electrode of a first-portion charging switch, and a control terminal of the first-portion charging switch is electrically connected to the first scan line. Meanwhile, the first portion is further electrically connected with a first-portion liquid crystal capacitor and a first-portion storage capacitor, wherein two ends of either the first-portion liquid crystal capacitor or the first-portion storage capacitor are electrically connected to a first electrode and a second electrode of a first-portion discharge switch, a control terminal of which discharge switch is electrically connected to the first scan line.

The above-mentioned second portion is electrically connected to the data line through a first electrode and a second electrode of a second-portion charging switch, a control terminal of which charging switch is electrically connected to the second scan line. The second portion is further electrically connected with a second-portion liquid crystal capacitor and a second-portion storage capacitor, wherein two ends of either the second-portion liquid crystal capacitor or the second-portion storage capacitor are electrically connected to a first electrode and a second electrode of a second-portion discharge switch, a control terminal of which discharge switch is electrically connected to the second scan line.

Further, the present disclosure also provides a method for driving a display panel, wherein the display panel comprises a plurality of data lines, a plurality of scan lines, and a plurality of sub-pixels, the data lines and the scan lines being arranged in a staggered manner to form a plurality of sub-pixel regions, and a pixel electrode in each of the sub-pixels comprising a main portion, a first portion, and a second portion, wherein the main portion is electrically connected with the first portion, said method comprising steps for driving two-dimensional display and/or three-dimensional display:

wherein the steps for driving the two-dimensional display, during a positive/negative polarity reversal period, include:
transmitting, at a first time point, a data signal to the main portion through a data line so that the main portion has a main-portion voltage, by means of which the first portion has a first-portion voltage that is different from the main-portion voltage; and
transmitting, at a second time point, a data signal to the second portion through the data line, so that the second portion has a second-portion voltage that differs from either of the main-portion voltage and the first-portion voltage; and
wherein the steps for driving the three-dimensional display comprise:
   turning the second portion into a black area and maintaining its dark state; and
   transmitting a data signal to the main portion through the data line so that the main portion has a main-portion voltage, by means of which the first portion has a first-portion voltage that is different from the main-portion voltage.

According to an embodiment of the present disclosure, the first portion obtains the first-portion voltage by its series connection and voltage division with the main portion.

According to an embodiment of the present disclosure, in the steps for driving the three-dimensional display, it is preferred to carry out black frame insertion during vertical retrace so as to form the second portion into the black area.

Compared with the prior art, one or more embodiments of the present disclosure may have the following advantages.

1. The display panel of the present disclosure uses a pixel structure having a 1D2G type of structure (comprising one data line and two scan lines), three portions (a portion Main, a portion Sub1 and a portion Sub2), and twelve domains. With such pixel structure, not only the lower color shift for two-dimensional display can be achieved through different voltages in said three portions from one another under the two-dimensional display mode, but also the lower color shift for three-dimensional display can be achieved through a voltage difference between the portions Main and Sub1 after the portion Sub2 is formed with a relatively wide light shading area necessary for the three-dimensional display under the three-dimensional display mode. Thus, with the penetration of the two-dimensional display ensured, a compatibility of two-dimensional display and three-dimensional display is achieved, and a better effect of low color shift is further realized in both the two-dimensional display and the three-dimensional display, thereby improving the image display quality.

2. in the pixel structure of the present disclosure, the main portion is electrically connected with the first portion, and the first portion is exerted with a first-portion voltage preferably by its series connection and voltage division with the main portion. Such pixel structure is much simpler, thereby reducing the complexity of the production process.

Other features and advantages of the present disclosure will be further explained in the following description, and are partially apparent from the description or understood through implementing the present disclosure. The objectives and advantages of the present disclosure will be achieved through the structure specifically pointed out in the description, claims, and the accompanying drawings.

### BRIEF DESCRIPTION OF THE ACCOMPANYING DRAWINGS

The accompanying drawings are configured to provide a further understanding of the present disclosure, and constitute a part of the description to explain the present disclosure together with the embodiments of the present disclosure, rather than limiting to the present disclosure. In the accompanying drawings:

FIG. 1 is a structural diagram of a display panel according to Embodiment 1 of the present disclosure;

FIG. 2 is a structural diagram of a pixel electrode in a sub-pixel according to Embodiment 1 of the present disclosure;

FIG. 3 is an equivalent circuit diagram of the sub-pixel of FIG. 2; and

FIG. 4 is a diagram showing operating condition of the pixel electrode in the sub-pixel of FIG. 2 under a three-dimensional display mode.

### DETAILED DESCRIPTION OF THE EMBODIMENTS

To make the objectives, technical solutions and advantages of the present disclosure more apparent, the present disclosure will be described in detail with reference to the following specific embodiments and accompanying drawings.

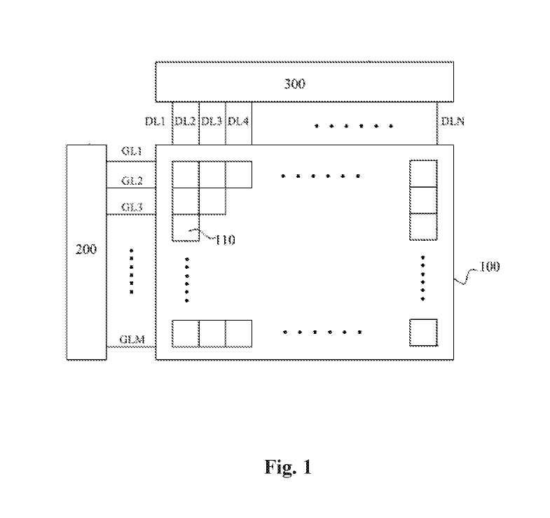

FIG. 1 is a structural diagram of a display panel depicted according to Embodiment 1 of the present disclosure. The display panel comprises an image display area 100, a scan driving circuit 200, and a data driving circuit 300. The image display area 100 comprises an array formed by a staggered arrangement of a plurality of scan lines GL1 to GLM with a plurality of data lines DL1 to DLN, and a plurality of pixel structures 110 serving as elements of the array. In this case, the scan driving circuit 200, through the plurality of scan lines GL1 to GLM coupled thereto, delivers scan signals provided thereby to the pixel structures 110 in the image display area 100. The data driving circuit 300, through the plurality of data lines DL1 to DLN coupled thereto, delivers data signals provided thereby to the pixel structures 110 in the image display area 100.

Generally, one pixel structure 110 of a color display panel contains a red sub-pixel, a green sub-pixel, and a blue sub-pixel. In this embodiment, all of the sub-pixels use a structure of 1D2G type. That is, for one sub-pixel, a region of the sub-pixel (i.e., a pixel electrode region in the sub-pixel) is defined by a longitudinally positioned data line together with a first scan line and a second scan line both positioned horizontally.

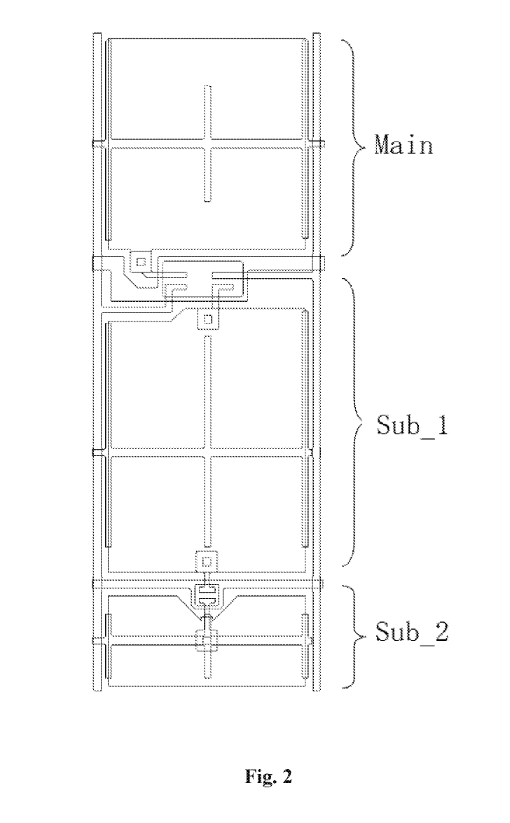

FIG. 2 is a structural diagram of a pixel electrode in the sub-pixel according to Embodiment 1 of the present disclosure. The pixel electrode is divided into three portions, i.e., a main portion Main, a first portion Sub1 and a second portion Sub2, wherein in a preferred manner, each of the portions is divided into four domains.

The main portion Main is configured to receive a scan signal Gn of the first scan line and thereby to receive, under the action of the scan signal Gn, a data signal Data of the data line, so as to have a main-portion voltage V_Main.

The first portion Sub1 is electrically connected to the main portion Main, and configured to receive the scan signal Gn of the first scan line and thereby to receive, under the action of the scan signal Gn, the main-portion voltage V_Main, so as to have a first-portion voltage V_Sub1.

The second portion Sub2 is configured to receive a scan signal Gn+1 of the second scan line and thereby to receive, under the action of the scan signal Gn+1, a data signal Data of the data line, so as to have a second-portion voltage V_Sub2.

In this case, the main-portion voltage V_Main, the first-portion voltage V_Sub1, and the second-portion voltage V_Sub2 should be different from one another, so that the LCD panel may realize low color shift under a two-dimensional display mode. Furthermore, when the LCD panel operates under a three-dimensional display mode, the second portion Sub2 disenables its display function but serves as a shading area. Meanwhile, since the main-portion voltage V_Main is different from the first-portion voltage V_Sub1, the effect of low color shift may be realized.

It should be noted that, in the present embodiment, the first scan line Gn and the second scan line Gn+1 are two neighboring scan lines with each other; however, it may be not limited thereto in practical applications.

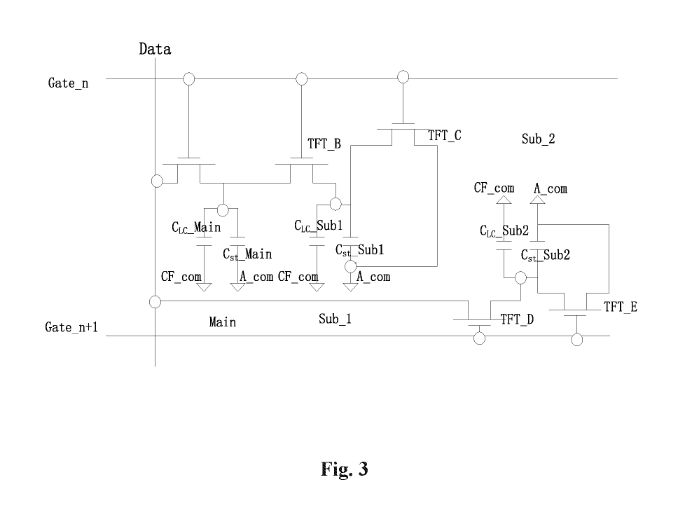

FIG. 3 is an equivalent circuit diagram of the sub-pixel shown in FIG. 2.

For the main portion Main, a main-portion charging switch TFT_A, through its first electrode and second electrode, is electrically connected to the data line and the main portion Main therebetween, and a control terminal of the charging switch TF_A is electrically connected to the first scan line to receive the scan signal Gn. Meanwhile, the main portion Main is also electrically connected to a storage capacitor Cst_Main and a liquid crystal capacitor Clc_Main. Under the action of the scan signal Gn, the charging switch TFT_A is activated, followed by transmission of the data signal Data of the data line to the storage capacitor Cst_Main and the liquid crystal capacitor Clc_Main via the switching element TFT_A, and then the storage capacitor Cst_Main and the liquid crystal capacitor Clc_Main each are charged, based on the data signal Data, and store corresponding potentials. As a result of this, the main portion Main has the corresponding main-portion voltage V_Main, so that the liquid crystal molecules associated with the main portion Main deflects accordingly, thus displaying the corresponding image data.

In a specific embodiment, the storage capacitor Cst_Main of the main portion may be constituted by the main portion Main and a common electrode A_com of an array substrate where the main portion is positioned, and the liquid crystal capacitor Clc_Main in the main portion may be constituted by the main portion Main and a common electrode CF_com of a color filter substrate.

For the first portion Sub1, a first-portion charging switch TFT_B is electrically connected, through its first and second electrodes, to the main portion Main and the first portion Sub1 therebetween, and a control terminal of the charging switch TFT_B is electrically connected to the first scan line to receive the scan signal Gn. Meanwhile, the first portion Sub1 is also electrically connected to a storage capacitor Cst_Sub1 and a liquid crystal capacitor Clc_Sub1, wherein two ends of either the storage capacitor Cst_Sub1 or the liquid crystal capacitor Clc_Sub1 are electrically connected to a first and a second electrodes of a discharge switch TFT_C respectively, and a control terminal of the discharge switch TFT_C is electrically connected to the first scan line to receive the scan signal Gn. Under the action of the scan signal Gn, the charging switch TFT_B is activated, which precedes transmission of the main-portion voltage V_Main to the storage capacitor Cst_Sub 1 and the liquid crystal capacitor Clc_Sub1 via the switching element TFT_B, and then the storage capacitor Cst_Sub1 and the liquid crystal capacitor Clc_Sub1 are each charged, based on the main-portion voltage V_Main, and thereby store corresponding potentials. In the meanwhile, since the discharge switch TFT_C is also activated, the potentials of the storage capacitor Cst_Sub1 and the liquid crystal capacitor Clc_Sub1 decline due to electric leakage of the switching element TFT_C. Based on this, the first portion Sub1 has the first-portion voltage V_Sub1, a level of which is different from that of the main-portion voltage V_Main, so that the liquid crystal molecules associated with the first portion Sub1 deflects accordingly, thus displaying the corresponding image data.

In a specific embodiment, the storage capacitor CstSub_1 of the first portion may be formed by the first portion Sub1 and a common electrode A_com of an array substrate where the first portion is positioned, and the liquid crystal capacitor Clc_Sub1 of the first portion may be constituted by the first portion Sub1 and a common electrode CF_com of a color filter substrate.

For the second portion Sub2, a second-portion charging switch TFT_D is electrically connected, through a first and a second electrodes thereof, between the data line and the second portion Sub2, and a control terminal of the charging switch TFT_D is electrically connected to a second scan line to receive the scan signal Gn+1. Meanwhile, the second portion Sub2 is also electrically connected to a storage capacitor Cst_Sub2 and a liquid crystal capacitor Clc_Sub2, wherein two ends of either the storage capacitor Cst_Sub2 or the liquid crystal capacitor Clc_Sub2 are electrically connected to a first and a second electrodes of a discharge switch TFT_E, and a control terminal of the discharge switch TFT_E is electrically connected to the second scan line to receive the scan signal Gn+1. Under the action of the scan signal Gn+1, the charging switch TFT_D is activated, so that the data signal Data of the data line is transmitted to the storage capacitor Cst_Sub2 and the liquid crystal capacitor Clc_Sub2 via the switching element TFT_D, and the storage capacitor Clc_Sub2 and the liquid crystal capacitor Cst_Sub2 are charged based on the data signal Data and thereby store corresponding potentials. In the meanwhile, since the discharge switch TFT_E is also activated, the potentials of the storage capacity Cst_Sub2 and the liquid crystal capacitor Clc_Sub2 decline due to electric leakage of the switching element TFT_E. As a result of this, the second portion Sub2 has the second-portion voltage V_Sub2, a level of which is different from that of the main-portion voltage V_Main, so that the liquid crystal molecules associated with the second portion Sub2 deflects accordingly, thus displaying the corresponding image data.

In a specific embodiment, the storage capacitor Cst_Sub2 of the second portion may be formed by the second portion Sub2 and a common electrode A_com of an array substrate where the second portion is located, and the liquid crystal capacitor Clc_Sub2 of the second portion may be constituted by the second portion Sub2 and a common electrode CF_com of a color filter substrate.

It should be noted that a pixel electrode potential in the sub-pixel as mentioned above or below, such as V_Main, V_Sub1, and V_Sub2, may refer to a voltage of a pixel electrode per se, or alternatively, to a voltage difference of the pixel electrode relative to the common electrode A_com of the array substrate or relative to the common electrode CF_com of the color filter substrate, as generally known in the art. Accordingly, the meaning of the pixel electrode potential in the present disclosure is not limited to that as defined by the embodiments of the present disclosure.

Each of the above charging switches and discharge switches is preferably made of a thin film transistor, a first electrode and a second electrode of which are typically the drain and the source, and a control terminal of which is the gate.

Detailed description will be made below about the circuit operating condition and the voltage changes in respective portions of a pixel electrode in the case of a two-dimensional display mode and a three-dimensional display mode.

During a positive polarity reversion period in term of the two-dimensional display mode, a voltage of the data signal is higher than that of the common electrode which in this embodiment refers to the common electrode common CF_com of the color filter substrate and/or the common electrode A_com of the array substrate.

1) In the case that a scan signal Gn of the first scan line is of a high level while a scan signal Gn+1 of the second scan line is low:

The charging switch TFT_A in the main portion is activated, so that the data signal Data of the data line is transmitted to the storage capacitor Cst_Main and the liquid crystal capacitor Clc_Main in the main portion via the charging switch TFT_A, and the storage capacitor Clc_Main and the liquid crystal capacitor Cst_Main in the main portion are charged based on the data signal Data and thereby store corresponding voltages, i.e., the main-portion voltage V_Main;

The charging switch TFT_B and the discharge switch TFT_C in the first portion are both activated, so that the main-portion voltage V_Main is transmitted to the liquid crystal capacitor Clc_and the storage capacitor Cst_Sub1 in the first portion via the charging switch TFT_B, and then the liquid crystal capacitor Clc_Sub1 and the storage capacitor Cst_Sub1 in the first portion are charged based on the main-portion voltage V_Main and thereby store corresponding voltages. At the same time, as the discharge switch TFT_C is also activated, the potentials of the liquid crystal capacitor Clc_Sub1 and the storage capacitor Cst_Sub1 in the first portion decline to the first-portion voltage V_Sub1, a level of which voltage is different from that of the main-portion voltage V_Main, due to electric leakage from the discharge switch TFT_C; and

The charging switch TFT_D and the discharge switch TFT_E in the second portion are deactivated, and thus the second-portion voltage V_Sub2 is zero.

2) In the case that the scan signal Gn of the first scan line is of a low level while the scan signal Gn+1 of the second scan line is high:

The charging switch TFT_A in the main portion is deactivated, and the charging switch TFT_B and the discharge switch TFT_C in the first portion are deactivated, so that the main-portion voltage V_Main and the first-portion voltage V_Sub1 are both unchanged; and

The charging switch TFT_D and the discharge switch TFT_E in the second portion are activated, so that the data signal Data of the data line is transmitted to the liquid crystal capacitor Clc_Sub2 and the storage capacitor Cst_Sub2 in the second portion via the charging switch TFT_D. Then, the liquid crystal capacitor Clc_Sub2 and the storage capacitor Cst_Sub2 in the second portion are charged based on the data signal Data and thereby store corresponding voltages. In the meanwhile, since the discharge switch TFT_E is activated, the potentials of the liquid crystal capacitor Clc_Sub2 and the storage capacitor Cst_Sub2 in the second portion may decline to the second-portion voltage V_Sub2, a level of which is different from that of the main-portion voltage V_Main, due to electric leakage from the discharge switch TFT_E.

During a negative polarity reversion period in term of the two-dimensional display mode, a voltage of the data signal is lower than that of the common electrode which in this embodiment refers to the common electrode common CF_com of the color filter substrate and/or the common electrode A_com of the array substrate.

1) In the case that a scan signal Gn of the first scan line is of a high level while a scan signal Gn+1 of the second scan line is low:

The charging switch TFT_A in the main-portion is activated, so that the data signal Data is transmitted to the liquid crystal capacitor Clc_Main and the storage capacitor Cst_Main in the main portion via the charging switch TFT_A. Then, the storage capacitor Clc_Main and the liquid crystal capacitor Cst_Main in the main portion are discharged based on the data signal Data and thereby store corresponding voltages, i.e., the main-portion voltage V_Main; and

The charging switch TFT_B and the discharge switch TFT_C in the first portion are both activated, so that the main-portion voltage V_Main is transmitted to the liquid crystal capacitor Clc_Sub1 and the storage capacitor Cst_Sub1 in the first portion via the charging switch TFT_B. Then, the liquid crystal capacitor Clc_Sub1 and the storage capacitor Cst_Sub1 in the first portion are discharged based on the main-portion voltage V_Main and thereby store corresponding voltages. At the same time, since the discharge switch TFT_C is also activated, the potentials of the liquid crystal capacitor Clc_Sub1 and the storage capacitor Cst_Sub1 in the first portion decline to the first-portion voltage V_Sub1, a level of which is different from that of the main-portion voltage V_Main, due to electric leakage from the discharge switch TFT_C; and

The charging switch TFT_D and the discharge switch TFT_E in the second portion are deactivated, and thus the second-portion voltage V_Sub2 is zero.

2) In the case that the scan signal Gn of the first scan line is of a low level while the scan signal Gn+1 of the second scan line is high:

The charging switch TFT_A in the main portion is deactivated, while the charging switch TFT_B and the discharge switch TFT_C in the first portion are deactivated, so that the main-portion voltage V_Main and the first-portion voltage V_Sub1 are both unchanged; and

The charging switch TFT_D and the discharge switch TFT_E in the second portion are activated, so that the data signal Data on the data line is transmitted to the liquid crystal capacitor Clc_Sub2 and the storage capacitor Cst_Sub2 in the second portion via the charging switch TFT_D. Then, the liquid crystal capacitor Clc_Sub2 and the storage capacitor Cst_Sub2 in the second portion are discharged based on the data signal Data and thereby store corresponding voltages. In the meanwhile, since the discharge switch TFT_E is activated, the potentials of the liquid crystal capacitor Clc_Sub2 and the storage capacitor Cst_Sub2 in the second portion decline to the second-portion voltage V_Sub2, a level of which is different from that of the main-portion voltage V_Main, due to electric leakage from the discharge switch TFT_E.

In the above embodiment, a series connection between the main portion Main and the first portion Sub1 is formed substantially through the charging switch TFT_A of the main portion as well as the charging switch TFT_B and the discharge switch TFT_C of the first portion. Therefore, with respect to a voltage V_Data which is a representative of the data signal Data, the main-portion voltage V_Main=V_Data×(RA+RB)/(RA+RB+RC), and the first-portion voltage V_Sub1=V_Data×RC/(RA+RB+RC), wherein RA, RB, and RC each are equivalent resistances of the charging switch TFT_A of the main portion, and the charging switch TFT_B and the discharge switch TFT_C of the first portion, respectively. Further, the second portion obtains the second-portion voltage V_sub2, a level of which differs from that of the main-portion voltage V_Main and the first-portion voltage V_Sub1, by the control of the charging switch TFT_D and the discharge switch TFT_E in the second portion. In this way, the main-portion voltage, the first-portion voltage, and the second-portion voltage in the pixel electrode are different from one another regardless of whether it is during the positive polarity reversion period or the negative polarity reversion period. This results significant differences in images displayed by these three portions, thereby achieving a low color shift display under the two-dimensional display mode.

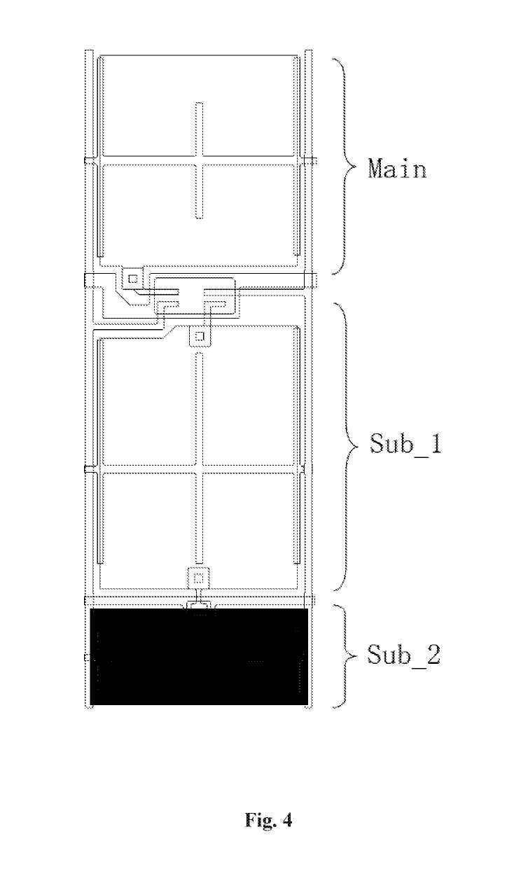

FIG. 4 is diagram of operating condition of the pixel electrode in the sub-pixel of FIG. 2 under a three-dimensional display mode. In order to achieve low color shift display in the three-dimensional display mode, the second portion in the pixel electrode is configured to act as a light shading area for three-dimensional display, so as to not only ensure a sufficient shading distance between two upper and lower lines of a pixel structure, but also obtain a significant voltage difference between the main portion and the first portion. In this embodiment, it is preferable to peiform black frame insertion to the second portion during vertical retrace, so that the second portion turns into a black area. Then, the scan signal Gn+1 taking charge of operation of the second portion is closed so that the second-portion voltage V_Sub2 is zero, which keeps the second portion to be dark so as to avoid light leakage due to electric leakage. Similar to the two-dimensional display mode, the data signal is transmitted to the main and first portions via the data lines simultaneously, and thus the main portion and the first portion each have a main-portion voltage and a first-portion voltage respectively, between which two voltages there is a predetermined voltage difference. Due to the voltage difference between the main and first-portion voltages, there is a significant difference in images displayed by the main portion and the first portion, by means of which it is possible to effectively solve the problem of color shift during the three-dimensional display.

The above is only preferred embodiments of the present disclosure, but the scope of the present disclosure is not limited thereto, and changes or replacement that can be thought of by any person skilled in the art should fall within the scope of the present disclosure. Accordingly, the scope of the disclosure should be subject to the scope of the claims.

1. A pixel structure comprising a plurality of sub-pixels, a pixel electrode of each of the sub-pixels comprising:
a main portion, configured to receive a scan signal of a first scan line, so as to receive a data signal of a data line and then have a main-portion voltage;
a first portion, electrically connected to the main portion and configured to receive the scan signal of the first scan line, so as to receive the main-portion voltage and then have a first-portion voltage; and
a second portion, configured to receive a scan signal of a second scan line, so as to receive the data signal of the data line and then have a second-portion voltage,
wherein the main-portion voltage, the first-portion voltage, and the second-portion voltage are different from one another.

2. The pixel structure according to claim 1, wherein the main portion is electrically connected to the data line through a first electrode and a second electrode of a main-portion charging switch, a control terminal of which charging switch is electrically connected to the first scan line; and
wherein the main portion is further electrically connected with a main-portion liquid crystal capacitor and a main-portion storage capacitor.

3. The pixel structure according to claim 1, wherein the first portion is electrically connected to the main portion through a first electrode and a second electrode of a first-portion charging switch, a control terminal of which charging switch is electrically connected to the first scan line; and
wherein the first portion is further electrically connected with a first-portion liquid crystal capacitor and a first-portion storage capacitor, wherein two ends of either the first-portion liquid crystal capacitor or the first-portion storage capacitor are electrically connected to a first electrode and a second electrode of a first-portion discharge switch, a control terminal of which discharge switch is electrically connected to the first scan line.

4. The pixel structure according to claim 2, wherein the first portion is electrically connected to the main portion through a first electrode and a second electrode of a first-portion charging switch, a control terminal of which charging switch is electrically connected to the first scan line; and
wherein the first portion is further electrically connected with a first-portion liquid crystal capacitor and a first-portion storage capacitor, wherein two ends of either the first-portion liquid crystal capacitor or the first-portion storage capacitor are electrically connected to a first electrode and a second electrode of a first-portion discharge switch, a control terminal of which discharge switch is electrically connected to the first scan line.

5. The pixel structure according to claim 1, wherein the second portion is electrically connected to the data line through a first electrode and a second electrode of a second-portion charging switch, a control terminal of which charging switch is electrically connected to the second scan line; and
wherein the second portion is further electrically connected with a second-portion liquid crystal capacitor and a second-portion storage capacitor, wherein two ends of either the second-portion liquid crystal capacitor or the second-portion storage capacitor are electrically connected to a first electrode and a second electrode of a second-portion discharge switch, a control terminal of which discharge switch is electrically connected to the second scan line.

6. The pixel structure according to claim 2, wherein the second portion is electrically connected to the data line through a first electrode and a second electrode of a second-portion charging switch, a control terminal of which charging switch is electrically connected to the second scan line; and
wherein the second portion is further electrically connected with a second-portion liquid crystal capacitor and a second-portion storage capacitor, wherein two ends of either the second-portion liquid crystal capacitor or the second-portion storage capacitor are electrically connected to a first electrode and a second electrode of a second-portion discharge switch, a control terminal of which discharge switch is electrically connected to the second scan line.

7. The pixel structure according to claim 3, wherein the second portion is electrically connected to the data line through a first electrode and a second electrode of a second-portion charging switch, a control terminal of which charging switch is electrically connected to the second scan line; and
wherein the second portion is further electrically connected with a second-portion liquid crystal capacitor and a second-portion storage capacitor, wherein two ends of either the second-portion liquid crystal capacitor or the second-portion storage capacitor are electrically connected to a first electrode and a second electrode of a second-portion discharge switch, a control terminal of which discharge switch is electrically connected to the second scan line.

8. The pixel structure according to claim 4, wherein the second portion is electrically connected to the data line through a first electrode and a second electrode of a second-portion charging switch, a control terminal of which charging switch is electrically connected to the second scan line; and
wherein the second portion is further electrically connected with a second-portion liquid crystal capacitor and a second-portion storage capacitor, wherein two ends of either the second-portion liquid crystal capacitor or the second-portion storage capacitor are electrically connected to a first electrode and a second electrode of a second-portion discharge switch, a control terminal of which discharge switch is electrically connected to the second scan line.

9. The pixel structure according to claim 8, wherein the main-portion liquid crystal capacitor, the first-portion liquid crystal capacitor, and the second-portion liquid crystal capacitor are formed respectively by the main portion, the first portion, and the second portion with a common electrode of a color filter substrate; and
wherein the main-portion storage capacitor, the first-portion storage capacitor, and the second-portion storage capacitor are constituted respectively by the main portion, the first portion, and the second portion with a common electrode of an array substrate where the main portion, the first portion, and the second portion are located.

10. A display panel, comprising:
a plurality of data lines;
a plurality of scan lines, forming a plurality of sub-pixel regions by means of a staggered arrangement with the data lines; and
a plurality of sub-pixels, arranged inside the sub-pixel regions, a pixel electrode of each of the sub-pixels comprising:
a main portion, configured to receive a scan signal of a first scan line, so as to receive a data signal of a data line and then have a main-portion voltage;
a first portion, electrically connected to the main portion and configured to receive the scan signal of the first scan line, so as to receive the main-portion voltage and then have a first-portion voltage; and
a second portion, configured to receive a scan signal of a second scan line, so as to receive the data signal of the data line and then have a second-portion voltage,
wherein the main-portion voltage, the first-portion voltage, and the second-portion voltage are different from one another.

11. The display panel according to claim 10, wherein in the pixel electrode of each of the sub-pixels:
the main portion is electrically connected to the data line through a first electrode and a second electrode of a main-portion charging switch, and a control terminal of the main-portion charging switch is electrically connected to the first scan line; and the main portion is further electrically connected with a main-portion liquid crystal capacitor and a main-portion storage capacitor;
the first portion is electrically connected to the main portion through a first electrode and a second electrode of a first-portion charging switch, and a control terminal of the first-portion charging switch is electrically connected to the first scan line; and the first portion is further electrically connected with a first-portion liquid crystal capacitor and a first-portion storage capacitor, wherein two ends of either the first-portion liquid crystal capacitor or the first-portion storage capacitor are electrically connected to a first electrode and a second electrode of a first-portion discharge switch, a control terminal of which discharge switch is electrically connected to the first scan line; and
the second portion is electrically connected to the data line through a first electrode and a. second electrode of a second-portion charging switch, a control terminal of which charging switch is electrically connected to the second scan line; and the second portion is further electrically connected with a second-portion liquid crystal capacitor and a second-portion storage capacitor, wherein two ends of either the second-portion liquid crystal capacitor or the second-portion storage capacitor are electrically connected to a first electrode and a second electrode of a second-portion discharge switch, a control terminal of which discharge switch is electrically connected to the second scan line.

12. A method for driving a display panel, wherein the display panel comprises a plurality of data lines, a plurality of scan lines, and a plurality of sub-pixels, the data lines and the scan lines being arranged in a staggered manner to form a plurality of sub-pixel regions, and a pixel electrode in each of the sub-pixels comprising a main portion, a first portion, and a second portion, wherein the main portion is electrically connected with the first portion, said method comprising steps for driving two-dimensional display and/or three-dimensional display:
wherein the steps for driving the two-dimensional display, during a positive/negative polarity reversion period, comprise:
transmitting, at a first time point, a data signal to the main portion through a data line so that the main portion has a main-portion voltage, by means of which the first portion has a first-portion voltage that is different from the main-portion voltage; and
transmitting, at a second time point, a data signal to the second portion through the data line, so that the second portion has a second-portion voltage that differs from either of the main-portion voltage and the first-portion voltage; and
wherein the steps for driving the three-dimensional display comprise:
turning the second portion into a black area and maintaining its dark state; and
transmitting a data signal to the main portion through the data line so that the main portion has a main-portion voltage, by means of which the first portion has a first-portion voltage that is different from the main-portion voltage.

13. The method according to claim 12, wherein the first portion obtains the first-portion voltage by its series connection and voltage division with the main portion.

14. The method according to claim 12, wherein black frame insertion is performed during vertical retrace so as to form the second portion into the black area.

15. The method according to claim 13, wherein black frame insertion is performed during vertical retrace so as to form the second portion into the black area.
